(19) United States
(12) Patent Application Publication
(10) Pub. No.: US 2010/0196623 A1
(43) Pub. Date: Aug. 5, 2010

(54) FILM FORMING METHOD AND FILM FORMING APPARATUS

(76) Inventors: Kazuyoshi Honda, Osaka (JP); Yuma Kamiyama, Kyogo (JP); Kunihiko Bessho, Osaka (JP); Tomofumi Yanagi, Osaka (JP); Yasuharu Shinokawa, Osaka (JP); Toshitada Sato, Osaka (JP)

Correspondence Address: MCDERMOTT WILL & EMERY LLP, 600 13TH STREET, NW, WASHINGTON, DC, 20005-3096, US

(21) Appl. No.: 12/680,043

(22) PCT Filed: Sep. 9, 2008
(86) PCT No.: PCT/JP2008/002486

§ 371 Date: Mar. 25, 2010

(30) Foreign Application Priority Data
Oct. 9, 2007 (JP) 2007-263080
Nov. 2, 2007 (JP) 2007-285953
Nov. 6, 2007 (JP) 2007-288346

(51) Int. Cl. B05D 3/06; B05D 3/02; B05D 3/00; B05C 5/04

(52) U.S. Cl. 427/566; 427/294; 427/561; 118/726; 118/724

(57) ABSTRACT

The present invention provides a film forming method and a film forming apparatus each of which is capable of forming films at low cost. The film forming method of the present invention includes the steps of (i) melting a solid material 51 of a thin film to prepare a melted liquid, solidifying the melted liquid 51a to form a rod-shaped body 51b, and pulling out the rod-shaped body 51b, (ii) melting and supplying a part of the rod-shaped body 51b to a melted liquid (evaporation source) 51d, and (iii) using the melted liquid (evaporation source) 51d to form the thin film. The steps (i), (ii), and (iii) are carried out in vacuum.

### TECHNICAL FIELD

The present invention relates to a film forming method and a film forming apparatus.

### BACKGROUND ART

A thin film technology is widely used for an increase in performance of devices and a reduction in size of devices. By realizing thin-film devices using the thin film technology, conveniences for users improve, and environmental merits, such as protection of earth resources and a reduction in power consumption, can also be obtained. In the thin film technology, an increase in efficiency and a reduction in cost of thin film manufacturing are important. Therefore, various efforts are currently being continued to realize the increase in efficiency and the reduction in cost of the thin film manufacturing.

In order to increase the efficiency of the thin film manufacturing, it is effective to continuously form a film for a long period of time. For example, in the thin film manufacturing using vacuum deposition, it is effective to continuously supply material materials to an evaporation source.

A method for supplying the materials to the evaporation source is selected in consideration of the type of the material and conditions for film formation. Examples of the method for continuously supplying the materials to the evaporation source are a method for throwing particulate materials in the evaporation source, a method for exposing a rod-shaped material to the evaporation source, a method for putting the rod-shaped material into the evaporation source from a lower side of the evaporation source, and a method for pouring liquid materials into the evaporation source.

In the case of continuously supplying the materials to the evaporation source, the evaporation source easily changes in temperature by the supply of low-temperature materials. Then, the change in the temperature of the evaporation source causes a change in an evaporation rate of the material, and this may disturb the formation of the uniform film. To solve this problem, a method for supplying melted materials to the evaporation source has been proposed (Patent Documents 1 and 2 for example).

In the method of Patent Document 1, the melted materials are supplied to a deposition crucible in accordance with the consumption of the material in the crucible. In the method of Patent Document 2, a tip end of a rod-shaped evaporation material is melted by heating and supplied to the evaporation source. Patent Document 2 discloses a method for continuously detecting the position of the tip end of the evaporation material by an optical sensor and adjusting a feed rate of the evaporation material based on a detection signal of the optical sensor.

Various methods for manufacturing the rod-shaped material that is the evaporation material have also been proposed. For example, disclosed is a method for continuously or non-continuously transferring melted materials from a material reservoir to a crystallization chamber, solidifying the material while maintaining an upper melted phase, and taking out the solidified material to a lower side (Patent Document 3).

Moreover, disclosed is a device including a casting portion which melts silicon by electromagnetic induction in a bottomless crucible with the silicon not contacting an inner wall of the crucible and solidifies the melted liquid moving downward to form a rod-shaped ingot (Patent Document 4). This device includes a tubular heat retaining container which is set under the casting portion and receives the ingot moving downward from the casting portion and keeps the ingot warm.

Patent Document 1: Japanese Laid-Open Patent Application Publication No. 62-177174

Patent Document 2: Japanese Laid-Open Patent Application Publication No. 2-47259

Patent Document 3: Japanese Laid-Open Patent Application Publication No. 62-56395

Patent Document 4: Japanese Laid-Open Patent Application Publication No. 7-138012

### DISCLOSURE OF THE INVENTION

### Problems to be Solved by the Invention

The method for sequentially melting the rod-shaped material from the tip end thereof to supply the melted material to the evaporation source is an excellent method in that changes given to the evaporation source are small. However, the problem of the conventional method is its high cost.

One reason for the high cost is that a large amount of energy is needed when manufacturing the rod-shaped material. Manufacturing the rod-shaped material requires energies for melting the material and energies for cooling down the material formed in a rod shape. These energies need to be reduced to reduce the cost. Especially, in the case of using the material having a melting point of 1500° C. or higher or in the case of using the material whose volume expands when cooling, a large amount of energies are required to melt and cool down the material. Therefore, these energies are unignorable.

Another reason for the high cost is a cost for cutting the rod-shaped material and a cost for cleaning the cutting surface. In the case of using the material (such as silicon or germanium) which is high in hardness but easily breaks, it is difficult to increase a cutting rate. Therefore, the cost for cutting the material is especially high.

Still another reason for the high cost is a low use efficiency of the material. In a case where the rod-shaped material is sequentially melted from the tip end thereof to be supplied to the evaporation source, the rod-shaped material is moved while holding a terminal end portion of the rod-shaped material. In this case, the material in the vicinity of a held portion cannot be melted. Therefore, the use efficiency of the material becomes low. Especially in a case where the rod-shaped material is short (1,000 mm or shorter for example), a loss rate of the material becomes high. Moreover, even if the remaining material is remelted to form the rod-shaped material, the cost for remelting and forming is necessary.

In view of these situations, an object of the present invention is to provide a film forming method and a film forming apparatus, each of which is capable of forming films at low cost.

### Means for Solving the Problems

To achieve the above object, a film forming method of the present invention is a film forming method for forming a thin film, including the steps of: (i) melting a solid material of the thin film to prepare a melted liquid, solidifying the melted liquid to form a rod-shaped body, and pulling out the rod-shaped body; (ii) melting and supplying a part of the rod-shaped body to an evaporation source; and (iii) using the evaporation source to form the thin film, wherein the steps (i), (ii), and (iii) are carried out in vacuum.

Note that the “film” described in the present invention may be formed like a film from a macroscopic point of view. For example, a structure in which a plurality of minute columnar bodies are densely formed on the base material so as to be in the form of a film when viewed as a whole may be the “film” described in the present invention.

Moreover, a film forming apparatus of the present invention is a film forming apparatus configured to generate a secondary material from a primary material and evaporate the secondary material to form a thin film on a base material in vacuum, the film forming apparatus including: a vacuum chamber; an exhaust mechanism configured to exhaust air from the vacuum chamber; an evaporation source disposed in the vacuum chamber to evaporate the secondary material; a secondary material supplying mechanism including a first heating mechanism configured to heat the primary material in a solid state to prepare a melted liquid, a container configured to form a rod-shaped body from the melted liquid, a pullout mechanism configured to pull out the rod-shaped body, and a second heating mechanism configured to melt a part of the rod-shaped body and supply a melted material as the secondary material to the evaporation source; a base material feed mechanism configured to feed the base material to a position on which evaporated particles evaporated from the evaporation source are deposited; and a primary material replenishing mechanism configured to replenish the secondary material supplying mechanism with the primary material in the solid state.

In the present description, members and devices disposed in the vacuum chamber are the members and devices disposed inside a wall surface of the vacuum chamber, and in addition, the members and devices which are fixed to the wall surface of the vacuum chamber and whose functional portions are located under reduced pressure.

From a certain point of view, the film forming method and film forming apparatus of the present invention are respectively a deposition method and a deposition apparatus.

### EFFECTS OF THE INVENTION

In accordance with the film forming method and film forming apparatus of the present invention, even if the rod-shaped body is not adequately cooled down after it is formed, it can be remelted to form the thin film. Therefore, the cost for cooling the rod-shaped body when manufacturing the rod-shaped material can be reduced. In addition, since the rod-shaped body can be continuously supplied as the material of the thin film without cutting the rod-shaped body, the cost for cutting the rod-shaped material, the cost for cleaning a cutting surface of the rod-shaped material, and the loss of the rod-shaped material can be reduced. Therefore, the present invention can form films at low cost. Moreover, in accordance with the present invention, since the melted material of the thin film can be continuously replenished, stable film formation can be continuously carried out. Further, in the present invention, the low-boiling-point impurities and the holes can be removed when manufacturing the rod-shaped material. Therefore, the splash during film formation can be suppressed, and the high-purity thin film can be formed from the low-purity material. Moreover, in the present invention, operations from manufacturing of the rod-shaped material up to the film formation are carried out in vacuum. Therefore, it is possible to prevent water and the like from adhering to the rod-shaped material, and the splash during the film formation due to the water and the like can be suppressed.

### BRIEF DESCRIPTION OF DRAWINGS

FIG. 1(a) is a top view schematically showing a part of Embodiment 1 of a film forming apparatus of the present invention, and FIG. 1(b) is a side view (partial cross-sectional view) schematically showing a part of Embodiment 1 of the film forming apparatus of the present invention.

FIG. 2 are schematic diagrams showing examples of the shape of a recess of a melting region.

FIG. 3 is a diagram schematically showing an irradiation region of an electron beam with respect to a rod-shaped body and an evaporation crucible.

FIG. 4 is a diagram schematically showing Embodiment 1 of the film forming apparatus of the present invention.

FIG. 5 is a schematic diagram showing one example of the configuration of from a water-cooling copper crucible up to a pullout mechanism when a melted liquid is heated from above and cooled down from below.

FIG. 6 is a schematic diagram showing one example of the configuration of from a complex crucible up to the pullout mechanism when the melted liquid is heated from above and cooled down from below.

FIG. 7(a) is a top view schematically showing a part of Embodiment 2 of the film forming apparatus of the present invention, and FIG. 7(b) is a side view (partial cross-sectional view) schematically showing a part of Embodiment 2 of the film forming apparatus of the present invention.

FIG. 8 is a diagram showing one example of a chuck roller also serving as a rotating mechanism.

### REFERENCE SIGNS LIST

10 film forming apparatus

11 crucible (container)

11a melting region

11b shaping region

11c recess

11g groove

11h outlet port

11A water-cooling copper crucible

11B complex crucible

11Ba graphite component

11Bb water-cooling copper component

12 primary material replenishing mechanism

13 electron gun (first heating mechanism)

13a, 42a, 42b electron beam

14 solidification start line

20 pullout mechanism

21 chuck roller

22 cam mechanism (swing mechanism)

30 feed guide

31 roller

32 spring mechanism

35 secondary material supplying mechanism

38 rotating mechanism

39 rod-shaped body rotating roller

40 evaporation mechanism

41 (evaporation) crucible

41a recess

42 electron gun (second heating mechanism)

51 solid material

51a melted liquid

51b rod-shaped body

51c liquid droplet (melted liquid)

51d melted liquid (evaporation source)

71 vacuum chamber

72 exhaust unit

73 delivery roller

74a, 74b, 74c feed roller

75 can

76 take-up roller

77 shielding plate

77a opening

78 introduction tube

80 substrate

### BEST MODE FOR CARRYING OUT THE INVENTION

Hereinafter, embodiments of the present invention will be explained using examples. However, the present invention is not limited to the following embodiments. In the following explanation, a specific numerical value and a specific material may be used. However, the other numerical value and the other material may be used as long as the effects of the present invention can be obtained.

### Film Forming Method

A film forming method of the present invention is a method for forming a thin film and includes steps (i), (ii) and (iii) below.

In the step (i), a solid material (primary material) of the thin film is melted to prepare a melted liquid, the melted liquid is solidified to form a rod-shaped body, and the rod-shaped body is pulled out. The material is selected depending on the thin film to be formed. In a case where an evaporated material and a gas are caused to react with each other to form the thin film in the step (iii) described below, the melted material may be a part of the material constituting the thin film.

The thin film to be formed and the material of the thin film are not limited as long as the method of the present invention is applicable. Examples of the material are: 14 group elements, such as silicon, germanium, and tin; alloys containing the 14 group elements (such as an alloy containing silicon); and magnetic materials containing an element, such as cobalt.

One example of a method for melting the solid material is a method for irradiating the solid material with an electron beam. Heating by the irradiation of the electron beam is preferable since the solid material can be melted in a short period of time, and a film containing fewer impurities can be formed. However, the other heating method may be used as long as the effects of the present invention can be obtained. For example, resistance heating or heating by the application of a high-frequency wave may be used.

Normally, pulling out the rod-shaped body from the melted liquid is continuously carried out. By continuously pulling out the rod-shaped body, the uniform rod-shaped body can be formed. However, pilling out the rod-shaped body may be intermittently carried out as long as the effects of the present invention can be obtained. Examples of a method for pulling out the rod-shaped body from the melted liquid of the material will be described later.

The size of the rod-shaped body is not limited. As one example, the length of the rod-shaped body is in a range from 400 to 2,000 mm, and an area of a cross section perpendicular to a longitudinal direction thereof is in a range from 3 to 100 cm².

Normally, the concentration of impurities in the rod-shaped body is lower than the concentration of impurities in the unmelted solid material. This is because when heating and melting the solid material in the step (i), the impurity having a low boiling point is removed. In addition, normally, the ratio of holes in the rod-shaped body is lower than the ratio of holes in the unmelted solid material.

In the step (ii), a part (for example, a tip end) of the rod-shaped body pulled out in the step (i) is melted and supplied to an evaporation source. Herein, the rod-shaped body pulled out from the melted liquid in the step (i) is not cut out, but the tip end located opposite to the melted liquid is melted while pulling out the rod-shaped body, and the generated melted liquid is supplied to the evaporation source.

In the step (ii), a part of the rod-shaped body may be melted by the irradiation of the electron beam. The rod-shaped body may be melted by the other heating method as long as the effects of the present invention can be obtained. For example, the resistance heating or the heating by the application of the high-frequency wave may be used.

In the step (ii), the rod-shaped body may be supplied to the evaporation source by dropping the melted liquid of the rod-shaped body to the evaporation source. In this case, a position to which the melted liquid is dropped may be separated from a position where the material evaporates from the evaporation source. By separating these two positions, an influence of the dropping of the melted liquid on the evaporation source can be reduced.

In the step (iii), the thin film is formed using the evaporation source. Specifically, the material is evaporated by heating the evaporation source. Since the evaporated material is deposited on a base material, the thin film made of the material or the thin film containing the material is formed on the base material. Heating of the evaporation source may be carried out by, for example, the irradiation of the electron beam. The evaporation source may be heated by the other heating method as long as the effects of the present invention can be obtained. For example, the resistance heating or the heating by the application of the high-frequency wave may be used.

The quality and shape of the base material on which the thin film is formed are selected in consideration of the use of the thin film. Examples of the base material are a metal sheet, a synthetic resin sheet, and a laminate of these sheets.

In the film forming method of the present invention, the steps (i), (ii), and (iii) are carried out in vacuum. In this method, the rod-shaped body pulled out from the melted liquid is remelted and supplied to the evaporation source. Therefore, in the method of the present invention, cooling and cutting of the rod-shaped body are unnecessary, and the loss of the rod-shaped body does not occur. In order to efficiently remove low-boiling-point impurities in the material in the step (i), a pressure of the vacuum is preferably from 100 to 1,000 Pa.

In the film forming method of the present invention, the steps (i), (ii), and (iii) may be carried out simultaneously (concurrently). Moreover, in the film forming method of the present invention, the steps (i), (ii), and (iii) may be carried out simultaneously and continuously. In the case of continuously forming the film, normally, the steps (i), (ii), and (iii) are carried out simultaneously and continuously.

In the film forming method of the present invention, the steps (i), (ii), and (iii) may be carried out in one vacuum chamber or in a plurality of vacuum chambers coupled to one another. As one example, the steps (i) and (ii) may be carried out in one vacuum chamber.

In the film forming method of the present invention, a part of the rod-shaped body may be heated by the electron gun in the step (ii), and the evaporation source may be heated by the same electron gun in the step (iii). To be specific, the rod-shaped body and the evaporation source may be heated by one electron gun. In this case, the electron beam emitted from one electron gun scans so as to irradiate the rod-shaped body and the evaporation source.

In the film forming method of the present invention, when the material is supplied through one end of the crucible and heated and melted to prepare the melted liquid, and the melted liquid is then solidified by cooling down the melted liquid at the other end of the crucible to form the rod-shaped body in the step (i), the melted liquid may be cooled down from below through the crucible and heated from above. With this, since unidirectional solidification can be carried out from a lower portion to upper portion of the rod-shaped body, shrinkage cavities can be suppressed, stress can be eased, breaking of the rod-shaped body by residual stress can be suppressed, and the crucible and the rod-shaped body can be prevented from getting stuck with each other.

In the film forming method of the present invention, the material may be a material which causes volume expansion during solidification. Specifically, the material may be silicon or an alloy containing silicon.

In the film forming method of the present invention, the crucible may be made of a cooled metal. More specifically, the crucible may be made of a cooled copper.

In the film forming method of the present invention, a side of the crucible to which side the material is supplied and a side of the crucible at which side the rod-shaped body is formed may be made of different materials, and a heat transfer rate between the material of the side of the crucible to which side the material is supplied and the melted liquid of the material may be lower than a heat transfer rate between the material of the side of the crucible at which side the rod-shaped body is formed and the melted liquid of the material. In this case, the side of the crucible to which side the material is supplied may be made of graphite, and the side of the crucible at which side the rod-shaped body is formed may be made of a cooled metal.

In the present invention, a solidification start line of the rod-shaped body may exist on the cooled metal.

In the film forming method of the present invention, a side surface of the crucible and a bottom surface of the crucible may be made of different materials, and a heat transfer rate between the material of the side surface of the crucible and the melted liquid of the material may be lower than a heat transfer rate between the material of the bottom surface of the crucible and the melted liquid of the material.

The method for heating the melted liquid from above during solidification may be a method using the electron gun or may be a method using the resistance heating. A heating region during heating and melting and a heating region during solidification may be adjacent to each other.

Moreover, in the film forming method of the present invention, the rod-shaped body may be pulled out while being rotated in the step (i). In this case, the rod-shaped body may have a substantially circular cross-sectional shape.

In the film forming method of the present invention, the steps (i), (ii), and (iii) may be carried out in one vacuum chamber or in a plurality of vacuum chambers coupled to one another.

In the present invention, the rod-shaped body may be supplied to the evaporation source in the step (ii) by dropping a melted liquid generated by melting a part of the rod-shaped body.

In the film forming method of the present invention, ion plating may be used. In this case, particles evaporated from the evaporation source are ionized, and a voltage is applied to the base material. Thus, the particles are attracted to the base material by Coulomb force. A film forming apparatus configured to carry out this film forming method includes devices configured to realize the method. For example, the film forming apparatus includes an ionization device and power supply used in a known ion plating device.

### Film Forming Apparatus

The film forming apparatus of the present invention is an apparatus configured to form the thin film on the base material in vacuum. The film forming apparatus of the present invention can easily carry out the film forming method of the present invention. The explanations regarding the film forming method of the present invention is applicable to the film forming apparatus of the present invention. Therefore, a repetition of the same explanation may be avoided.

The film forming apparatus of the present invention is an apparatus configured to, in vacuum, generate a secondary material from the primary material and evaporate the secondary material to form the thin film on the base material. This apparatus includes a vacuum chamber, an exhaust mechanism, an evaporation source, a secondary material supplying mechanism, a base material feed mechanism, and a primary material replenishing mechanism.

The exhaust mechanism exhausts air from the vacuum chamber. The vacuum chamber and the exhaust mechanism are not limited. The vacuum chamber and the exhaust mechanism commonly used in a vacuum film forming apparatus can be used.

The evaporation source is disposed in the vacuum chamber. The secondary material evaporates from the evaporation source.

The secondary material supplying mechanism includes: a first heating mechanism configured to heat the primary material in a solid state to generate the melted liquid; a container configured to form the rod-shaped body from the melted liquid; a pullout mechanism configured to pull out the rod-shaped body; and a second heating mechanism configured to melt a part of the rod-shaped body and supply a melted material as the secondary material to the evaporation source.

The base material feed mechanism feeds the base material to a position on which the evaporated particles evaporated from the evaporation source are deposited. Thus, the thin film is formed on the base material.

The primary material replenishing mechanism replenishes the secondary material supplying mechanism with the primary material in the solid state.

The film forming apparatus of the present invention may include the other members and devices according to need.

The base material on which the thin film is formed may be a band-shaped substrate. In this case, the feed mechanism may include a first roller configured to feed the substrate and a second roller configured to take up the substrate. In accordance with this configuration, the thin film can be continuously formed on an elongated substrate. The band-shaped substrate is a substrate having a length of, for example, 30 to 5,000 m.

The container may include a melted liquid storing portion configured to store the melted liquid of the material and a shaping portion adjacent to the melted liquid storing portion. The shaping portion solidifies the melted liquid of the material to form the rod-shaped body.

The shaping portion may be provided with a groove through which the rod-shaped body passes. The width of the groove may increase from the melted liquid storing portion side toward the shaping portion side.

The first heating mechanism may include the electron gun. Moreover, the second heating mechanism may include the electron gun. In this case, the second heating mechanism may include a scanning mechanism configured to distribute the electron beam, emitted from the electron gun of the second heating mechanism, to the rod-shaped body and the evaporation source. The material supplied to the evaporation source may be heated by the electron gun of the second heating mechanism. Heating the rod-shaped body and heating the material supplied to the evaporation source may be carried out by different heating devices. A known scanning mechanism can be used as the scanning mechanism. For example, an electromagnetic scanning mechanism using an induction coil may be used.

The pullout mechanism may include a swing mechanism configured to swing the rod-shaped body. By pulling out the rod-shaped body while swinging the rod-shaped body, the rod-shaped body can be prevented from being adhered to the container and damaged.

The first heating mechanism may be disposed above the container, and a tail end of the heating region heated by the first heating mechanism may be provided on a side of the solidification start line of the rod-shaped body at which side the rod-shaped body is formed.

The pullout mechanism may include a rotating mechanism configured to rotate the rod-shaped body. With this, since it is possible to form the rod-shaped body having, for example, a substantially circular cross-sectional shape and fewer surface depressions and projections, the rod-shaped body is unlikely to break. In addition, since the rod-shaped body can be uniformly heated and melted, stability of the supply of the rod-shaped body can be improved.

### Embodiment 1 of Film Forming Method and Film Forming Apparatus

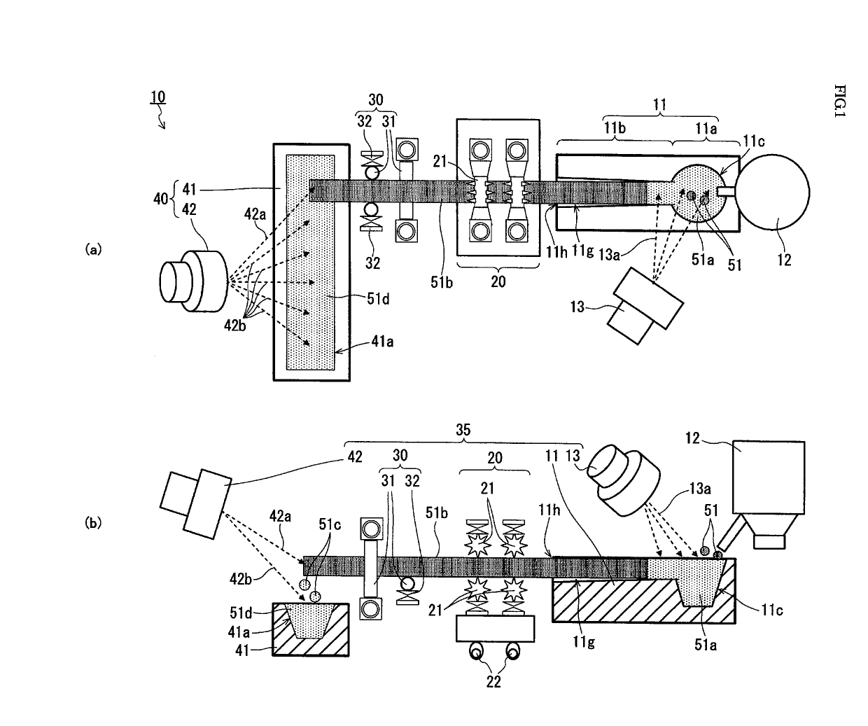

The configuration of Embodiment 1 of the film forming apparatus of the present invention is schematically shown in FIG. 1. In FIG. 1, the vacuum chamber, the exhaust mechanism, the base material, and the base material feed mechanism are omitted. FIG. 1(a) is a top view, and FIG. 1(b) is a side view (partial cross-sectional view).

A film forming apparatus 10 of FIG. 1 includes a crucible (container) 11, a primary material replenishing mechanism 12, an electron gun 13, a pullout mechanism 20, a feed guide 30, and an evaporation mechanism 40. The pullout mechanism 20 includes chuck rollers 21 and cam mechanisms 22. The feed guide 30 includes a roller 31 and a spring mechanism 32. The roller 31 is movably supported by the spring mechanism 32. The evaporation mechanism 40 includes an evaporation crucible 41 and an electron gun 42. The electron gun 42 serves as both a heating device of a secondary material supplying mechanism 35 and a heating device of the evaporation mechanism 40. The crucible 11 includes a melting region 11a where the material is melted and a shaping region 11b where the material is shaped. The crucible 11 can be made of various heat-resistant materials. Examples of the material of the crucible 11 are: metals, such as copper, iron, nickel, molybdenum, tantalum, and tungsten; alloys containing these metals; oxides, such as alumina, magnesia, and calcia; boron nitride; and carbon. The crucible 11 may be made of a combination of these materials. One typical example of the crucible 11 is a water-cooling copper hearth. A surface of the water-cooling copper hearth may be made of a carbon material (for example, graphite). A carbon material having a thickness of about 10 to 50 mm is disposed on the surface of a recess (below-described recess 11c) of the melting region 11a. With this, a cooling efficiency of the melted material can be adjusted, and a melting efficiency of the material can be increased. Moreover, the surface of a groove (below-described groove 11g) of the shaping region 11b is made of the carbon material having a thickness of about 10 to 30 mm. With this, a cooling rate of the material can be lowered. This is effective especially in a case where troubles, such as breaking, occur by rapid cooling of the material.

The primary material replenishing mechanism 12 replenishes the melting region 11a with a solid material 51. The shape of the solid material 51 is not limited and may be a particle shape, a mass shape, a rod shape, or a wire shape. As a method for feeding the material, the primary material replenishing mechanism 12 may use, for example, a parts feeder method, a basket method, a push rod method, or a slope sliding method. In the melting region 11a, the recess 11c for storing the melted material is formed. A planar shape of the recess 11c may be a rectangle, a circle, a combination of a rectangle and a circle, or the other shape. In a case where the planar shape of the recess 11c is a circle or an ellipse, one advantage is that the material is easily and uniformly melted.

Moreover, a vertical cross-sectional shape (see FIG. 1(b)) of the recess 11c may be a rectangle, a trapezoid, a drum shape, a rectangle having a round bottom, a trapezoid having a round bottom, or a drum shape having a round bottom. The vertical cross-sectional shape of the recess 11c may be a trapezoid (see FIGS. 2(b) and 2(d)) having a longer upper side than a bottom side or a trapezoid (see FIG. 2(f)) having a round bottom side. One advantage of such shape is that the material is easily and uniformly melted.

FIG. 2 show examples of the shape of the recess 11c. Each of FIGS. 2(a), 2(c), 2(e), and 2(g) shows the planar shape of an opening of the recess 11c. Each of FIGS. 2(b), 2(d), 2(f), and 2(h) shows the vertical cross-sectional shape of the recess 11c.

The solid material 51 supplied to the melting region 11a is heated and melted by an electron beam 13a emitted from the electron gun 13. Heating the solid material 51 may be carried out by a method other than the electron gun. For example, heating by a heater or induction heating may be carried out. The induction heating and the electron beam heating are preferable since the material can be melted in a short period of time, and the electron beam heating is especially preferable.

The electron gun 13 may be a straight gun or a deflection gun. The straight gun is advantageous in that an influence of a magnetic field on the electron gun 42 is small. A trajectory of the electron beam 13a may be bent several times. An influence of such bending on the electron gun 42 is small, and such bending contributes to suppression of contamination inside a barrel of the electron gun 13. An accelerating voltage of the electron beam 13a is set in consideration of the type of the solid material 51 and a throw-in rate of the solid material 51. As one example, the accelerating voltage of the electron beam 13a is in a range from −8 to −30 kV, and electricity thereof is in a range from 5 to 100 kW. In a case where the electricity is less than 5 kW, a melting rate of the material may not be enough. Moreover, in a case where the electricity exceeds 100 kW, scattering or bumping of the solid material 51 may occur.

The area of the opening (upper surface) of the recess 11c is set in consideration of the shape of the rod-shaped body to be manufactured, a feed rate of the solid material 51, and the power of a heat source (electron gun 13). The area of the opening of the recess 11c is normally from 500 to 40,000 mm² and is, for example, from 1,500 to 15,000 mm². In a case where the area of the opening is less than 500 mm², a part of the solid material 51 supplied from the primary material replenishing mechanism 12 tends to spill out from the melting region 11a. In contrast, in a case where the area of the opening exceeds 40,000 mm², heating energy required to melt the solid material 51 becomes too large in many cases, and this is uneconomical.

The solid material 51 is heated in the melting region 11a to be a melted liquid 51a. At this time, low-boiling-point impurity components contained in the solid material 51 are removed. As a result, the concentration of the low-boiling-point impurities in the rod-shaped body made of the melted liquid 51a becomes lower than the concentration of the low-boiling-point impurities in the solid material 51. Therefore, the method and apparatus of the present invention can significantly suppress splash which occurs during film formation due to the low-boiling-point impurities in an inexpensive material (material having a high impurity concentration). Such effect can be obtained in the case of using a comparatively inexpensive material, such as #441 grade metal silicon. The #441 grade metal silicon is silicon in which the concentrations of aluminum, iron, and calcium, which are typical impurities of silicon, are respectively 0.4 wt %, 0.4 wt %, and 0.1 wt % at most. These impurities are reduced or removed at a melting temperature of the metal silicon. In a case where the melting region 11a is heated by the electron beam, the melted liquid 51a is stirred by a convection flow, and a part of the surface of the melted liquid 51a becomes high in temperature. Therefore, the low-boiling-point impurities can be efficiently removed.

It is not preferable that the surface of the melted liquid 51a become too high in temperature due to too high power of the electron beam. This is because the evaporation of the material become significant. Therefore, it is preferable that the surface temperature of the melted liquid 51a be set to be high in temperature to a level that the evaporation of the material does not become significant. In order to remove the low-boiling-point impurities, the length of time for maintaining the melted liquid 51a at high temperature is also important. It is preferable that in the case of using the metal silicon as the solid material 51, the melted liquid 51a be maintained at high temperature for several minutes or longer. Therefore, it is preferable that a heating time in the melting region 11a and the shaping region 11b be set to several minutes or longer. The heating time can be adjusted in accordance with the below-described diameter and pullout rate of the rod-shaped body and the length of the heating region in each of the melting region 11a and the shaping region 11b. For example, in a case where the rod-shaped body has a diameter of 40 mm, the pullout rate may be 5 cm/min, and the total of the lengths of the heating regions in the melting region 11a and the shaping region 11b may be in a range from 10 to 50 cm.

The solid material 51 may include holes. However, by melting the solid material 51, the melted liquid 51a not including the holes is generated. By solidifying the melted liquid 51a to form the rod-shaped body, the number of holes in the rod-shaped body becomes smaller than the number of holes in the solid material 51. As a result, the amount of gas in the rod-shaped body can be reduced, and this produces an effect of reducing the splash during film formation. The metal silicon includes a large number of holes. Therefore, in the case of forming the film using the metal silicon, the splash tends to occur due to the low-boiling-point impurities and the holes. However, in accordance with the present invention, the holes and the low-boiling-point impurities in the material can be reduced, so that a significant effect of reducing the splash can be obtained.

The solid material 51 melted in the melting region 11a becomes the melted liquid 51a. As the solid material 51 is supplied, a part of the melted liquid 51a sequentially moves to the shaping region 11b. The groove 11g having an opening upper surface is formed in the shaping region 11b such that the melted liquid 51a becomes the rod-shaped body by solidification. A part of the melted liquid 51a moves to the shaping region 11b and is solidified as the temperature decreases. As a result, a part of the melted liquid 51a is shaped to become the rod-shaped body 51b when moving through the groove 11g. The shape of a region through which the material (the melted liquid 51a, the rod-shaped body 51b) passes is not limited as long as the rod-shaped body 51b is formed. For example, the shape of the region may be tubular.

The rod-shaped body 51b is pulled out from an outlet port 11h and moved to an upper side of the evaporation crucible 41. In order to easily pull out the rod-shaped body 51b from the outlet port 11h, the groove 11g preferably has an inverse tapered shape which is wider on the outlet port 11h side. Similarly, the groove 11g is preferably deeper on the outlet port 11h side. The shape of the groove 11g (or the tube) is set in consideration of the shape of the rod-shaped body 51b to be manufactured, the feed rate of the solid material 51, and the power of the heat source.

As one example, a cross section (cross section perpendicular to a direction in which the rod-shaped body 51b moves) of the groove 11g has a semicircular shape or a circular shape having a diameter of 20 to 80 mm at a boundary of the groove 11g and the melting region 11a and has a semicircular shape or a circular shape having a diameter of 24 to 90 mm at the outlet port 11h. Here, the cross section of the groove 11g gradually increases in size from one end of the melting region 11a toward the other end thereof (toward the outlet port 11h).

In a part of the shaping region 11b, the material (the melted liquid 51a, the rod-shaped body 51b) may be heated. The cooling rate of the material can be lowered by this heating. In addition, the melted liquid 51a can be smoothly moved to the shaping region 11b by this heating. Further, the breaking, warping, and cavity generation of the rod-shaped body 51b, which are caused due to too high cooling rate of the material in the shaping region 11b, can be suppressed by this heating.

The method for heating the material in the shaping region 11b may be the same as or different from the method for heating the material in the melting region 11a. For example, the heating in the melting region 11a may be carried out by the electron gun 13, and the heating in the shaping region 11b may be carried out by a resistance heater. Moreover, the heating in the melting region 11a and the heating in the shaping region 11b may be carried out by distributing the electron beam emitted from the electron gun 13.

The heating in a part of the shaping region 11b may be carried out such that a melted state of the melted liquid 51a is maintained. Moreover, the heating in a part of the shaping region 11b may be carried out such that the material having been solidified in the shaping region 11b remelts.

In the film forming apparatus 10, the melted liquid 51a of the material is heated from above (from the opening surface side). In addition, the melted liquid 51a can be cooled down from a contact surface contacting the crucible 11. As above, in the film forming method and film forming apparatus of the present invention, the melted liquid 51a may be heated from the opening surface (from above) and cooled down from the container side (from below). In accordance with this configuration, the solidification of the melted liquid 51a starts from the contact surface contacting the container and completes at the opening surface. To be specific, by suppressing the solidification of the upper surface of the melted liquid 51a and carrying out the unidirectional solidification from the lower portion toward upper portion of the melted liquid 51a, a portion which absorbs the stress during solidification and the change in volume due to the stress can be secured at the upper portion of the melted liquid 51a, so that the breaking of the rod-shaped body by the residual stress can be suppressed. In addition, the rod-shaped body and the crucible can be suppressed from getting stuck with each other. Moreover, with this, the melted liquid 51a is always supplied to a solidification surface from above, the suppression of the shrinkage cavity can be expected. The present mode is especially useful in a case where the material is a material, such as silicon or an alloy containing silicon, which causes the volume expansion during solidification.

FIG. 5 is a schematic diagram showing one example of the configuration of from a water-cooling copper crucible 11A up to the pullout mechanism 20 when the melted liquid 51a is heated from the opening surface (from above) and cooled down from the container side (from below).

In FIG. 5, the solid material 51 in the form of a particle is supplied to the water-cooling copper crucible 11A form a left end of FIG. 5, is heated by the electron gun 13 to become the melted liquid 51a, is cooled down as it moves to the right side of FIG. 5, becomes the rod-shaped body 51b in a solid state, and is pulled out by the pullout mechanism 20. In FIG. 5, the recess 11c is not formed but may be formed.

In FIG. 5, the electron gun 13 is used to control a solidification direction and a solidification rate by melting the solid material 51 and heating the melted liquid 51a. In order to melt the material, the heating rate of the material at a material entrance portion needs to be higher than the cooling rate of the material cooled by the crucible. However, in order to solidify the melted liquid, the heating rate of the material at a rod-shaped body exit portion needs to be lower than the cooling rate of the material cooled by the crucible. To be specific, it is desirable that in one crucible, heating at the material entrance portion and heating at the rod-shaped body exit portion be carried out by different outputs. In addition, it is desirable that in order to surely carry out the unidirectional solidification from the lower portion toward the upper side, the heating region in which the material is melted and the heating region in which the melted liquid is solidified be adjacent to each other, and the heating be carried out without interruption. Therefore, the heating by the irradiation of the electron ray is suitable since the directivity is high as the heating method, and the output is finely adjustable. Moreover, the electron gun is preferably provided as the heat source. However, by providing the heater instead of the electron gun, the heating by the other heating method, such as resistance heating, can be carried out.

By adjusting the output of the electron gun 13, the solid material 51 having been put into the water-cooling copper crucible 11A through one end thereof is heated and melted in the water-cooling copper crucible 11A. The melted liquid 51a of the material contacts the surface of the water-cooling copper crucible 11A to start the solidification. At this time, since the melted liquid 51a is heated from above by the electron gun 13, the solidification rate at the upper portion of the melted liquid becomes low, and the rod-shaped body 51b shows a unidirectional solidification characteristic from the lower portion to the upper portion. At this time, since the solidification of the rod-shaped body starts from a contact point between the cooled crucible and the melted liquid, the adhesion between the crucible and the rod-shaped body tends to occur. Therefore, it is preferable that water-cooling copper be used as a material of the crucible. Here, the reason why the water-cooling copper is used as the material of the crucible is because in a case where copper having extremely high heat conductivity is used while being cooled down by water and contacts the melted liquid of a metal or a semiconductor material, the copper is unlikely to be eroded, and the rod-shaped body and the crucible can be suppressed from getting stuck with each other by the adhesion. Moreover, the crucible using a metal, such as iron or steel, which can obtain the same effect as the copper, can be used instead of copper, and the crucible which carries out oil cooling or gas cooling can be used instead of water cooling. In the method for cooling down the melted liquid from the upper portion thereof, the lower portion of the rod-shaped body is lastly solidified. Therefore, the stress concentrates on the lower portion of the rod-shaped body, and the lower portion of the rod-shaped body deforms. Thus, the rod-shaped body tends to get stuck with the crucible, or the rod-shaped body tends to break. However, by carrying out the unidirectional solidification from the lower portion to the upper portion, the stress can be absorbed by the opening upper surface, so that it is possible to suppress the rod-shaped body from breaking, generating the shrinkage cavity, and getting stuck with the crucible by the deformation of the rod-shaped body.

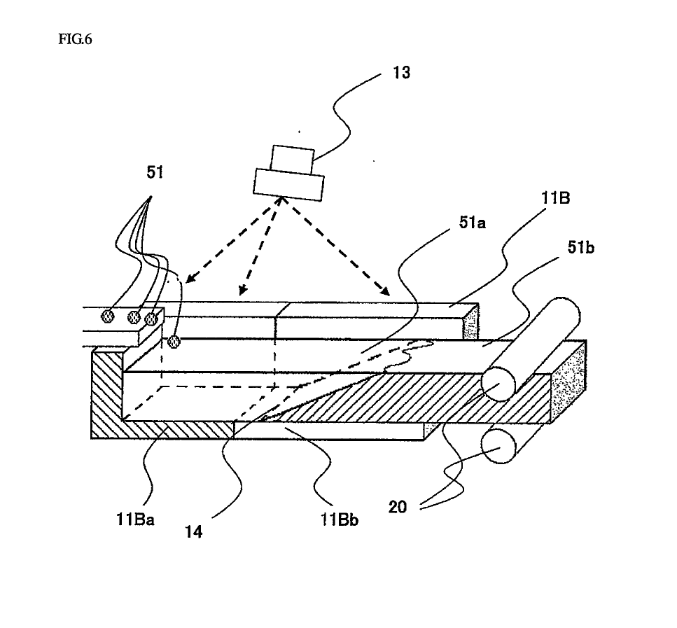

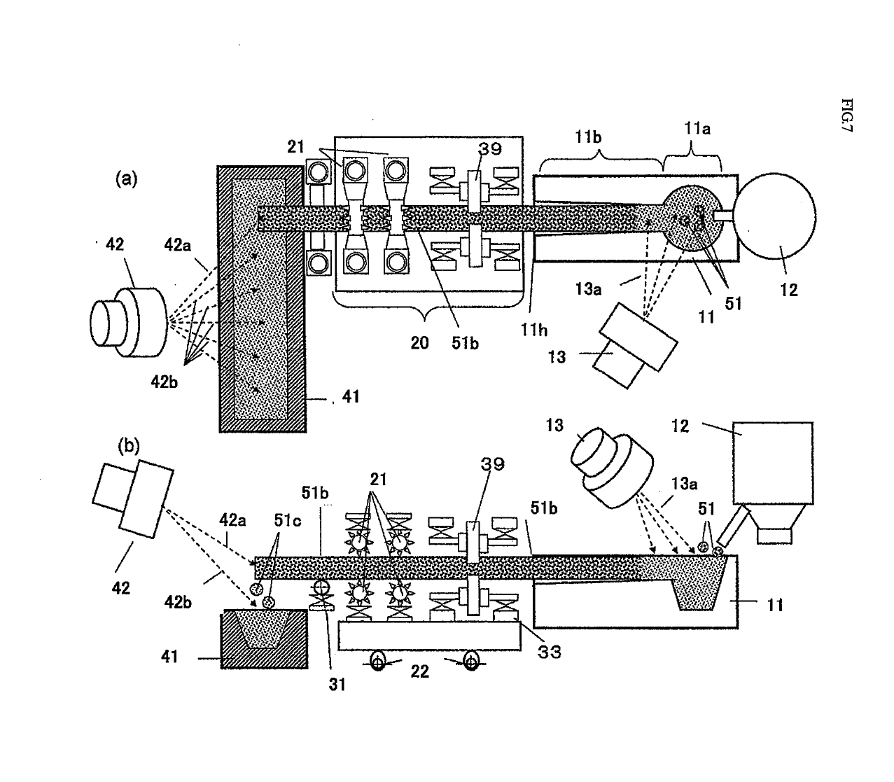

FIG. 6 is a schematic diagram showing one example of the configuration of from a complex crucible 11B to the pullout mechanism 20 when the melted liquid 51a is heated from the opening surface (from above) and cooled down from the container side (from below).

In FIG. 5, the crucible is made of one material. However, FIG. 6 is different from FIG. 5 in that a complex crucible is used, in which a side thereof to which side the material is supplied is made of a material having a low heat transfer rate, and a side thereof at which side the rod-shaped body is formed is made of a material having a high heat transfer rate. With this configuration as compared to a case where the crucible is made of one material, the amount of over heat during melting can be reduced, and the amount of cooling on the side thereof at which side the rod-shaped body is formed can be maintained at a high level.

As shown in FIG. 6, the present mode uses the complex crucible 11B in which the side thereof to which side the material is supplied is made of a material, such as a graphite component 11Ba, having a low heat transfer rate with the melted liquid 51a of the material, and the side thereof at which side the rod-shaped body is formed connected to the side thereof to which side the material is supplied is made of a material, such as a water-cooling copper component 11Bb, having a high heat transfer rate with the melted liquid 51a of the material. In this case as compared to a case where the water-cooling copper crucible 11A shown in FIG. 5 is used, the cooling at the graphite component 11Ba is suppressed. Therefore, the melting of the material by lower energy can be expected. Moreover, by continuously carrying out the cooling at the water-cooling copper component 11Bb, the unidirectional solidification in the same upper direction as in FIG. 5 can be achieved. However, since the graphite component 11Ba is not cooled down by water, it is easily heated, and the graphite and the melted liquid 51a may react with each other to cause the adhesion during solidification of the melted liquid. Therefore, it is desirable that by balancing between the amount of heat input from the electron gun 13 and the pullout rate of the rod-shaped body 51b, a solidification start line 14 of the rod-shaped body be maintained on the water-cooling copper component 11Bb, and the adhesion between the graphite and the rod-shaped body by the solidification of the melted liquid be suppressed. Moreover, it is desirable that in order to prevent the adhesion between the rod-shaped body and the crucible by the melted liquid having flowed into the gap between the graphite component and the water-cooling copper component, the graphite component and the water-cooling copper component be caused to be in close contact with each other by outside pressure. At this time, if there is a difference in level at a joint surface between the water-cooling copper component and the graphite component, the crucible and the rod-shaped body are adhered to each other or get stuck with each other. Therefore, it is preferable that the joint surface be a flat and smooth surface without the difference in level.

Moreover, the crucible 11 is configured such that a side surface thereof and a bottom surface thereof are made of different materials, and the heat transfer rate between the material of the side surface and the melted liquid 51a of the material becomes lower than the heat transfer rate between the material of the bottom surface and the melted liquid 51a of the material. With this, the solidification in a horizontal direction from the side surface can be suppressed, and the unidirectional solidification characteristic of the rod-shaped body can be improved.

Return to the explanation of FIG. 1. The rod-shaped body 51b is pulled out from the shaping region 11b by the pullout mechanism 20. The pullout mechanism 20 includes the chuck rollers 21 each having a convex portion. The rod-shaped body 51b is sandwiched by a plurality of chuck rollers 21 and can be moved by rotating the chuck rollers 21. A power for sandwiching the rod-shaped body 51b is set in consideration of the material, shape, and pullout rate of the rod-shaped body 51b. The power may be in a range from 29.4 to 490 N (3 to 50 kgf) for example. If the sandwiching power is too low, the rod-shaped body 51b may slip, and the rod-shaped body 51b may not be moved smoothly. In contrast, if the sandwiching power is too high, the rod-shaped body 51b may deform or break.

The shape of the side surface of the rod-shaped body 51b is not uniform in many cases. Therefore, it is preferable that in order to deal with the change in shape of the side surface of the rod-shaped body 51b, the chuck roller 21 be supported by a cushioning mechanism, such as a spring.

A plurality of convex portions are formed on an outer peripheral surface of the chuck roller 21. The convex portion may have a needle shape, a conical shape, a pyramid shape, a truncated cone shape, or a truncated pyramid shape. The convex portion having the truncated cone shape or the truncated pyramid shape has the advantage that the durability is high. Moreover, a gear-shaped chuck roller also has the advantage that the durability is high. For example, the convex portion having the truncated cone shape may be formed such that an upper surface thereof has a radius of 0.3 to 2 mm, a bottom surface thereof has a radius of 0.5 to 4 mm, and a height thereof is 0.5 to 5 mm.

The diameter of the chuck roller 21 may be uniform or may be changed by location. By configuring the chuck roller 21 such that a portion thereof sandwiching the rod-shaped body 51b is smaller in diameter than the other portion thereof, the improvement of a chuck characteristic and an effect of preventing the rod-shaped body 51b from meandering can be obtained. For example, the diameter of the chuck roller 21 is in a range from 10 to 70 mm at a chuck position of the rod-shaped body 51b. If the diameter of the chuck roller 21 is too small, the chuck roller 21 may bend. Moreover, if the diameter of the chuck roller 21 is too large, equipment becomes too large, and the cost of the equipment increases. In order to prevent the rod-shaped body 51b from meandering, it is effective to decrease the diameter of the chuck roller 21 at the chuck position and use plural pairs of chuck rollers 21.

When pulling out the rod-shaped body 51b, the rod-shaped body 51b may be pulled out while being swung. By this swinging, the adhesion between the rod-shaped body 51b and the crucible 11 can be prevented, and friction between the rod-shaped body 51b and the crucible 11 can be reduced. The swinging of the rod-shaped body 51b is especially effective in a case where the shaping region 11b has the groove 11b. For example, a swinging direction is a vertical direction and/or a horizontal direction. By pulling out the rod-shaped body 51b while swinging the rod-shaped body 51b in the vertical direction, the rod-shaped body 51b can be pulled out smoothly. For example, the swinging of the rod-shaped body 51b can be carried out by swinging a portion of the pullout mechanism 20 which portion sandwiches the rod-shaped body 51b. In the film forming apparatus 10, the chuck roller 21 is swung in the vertical direction by the cam mechanism 22. The width of the swinging may be in a range from 1 to 10 mm for example.

The mechanism and method for pulling out the rod-shaped body 51b are not limited to the mechanism and method of the film forming apparatus 10. For example, a roller different in shape from the chuck roller 21 may be used. Moreover, instead of the chuck roller 21, a mechanism in which a chuck portion slides may be used. In this case, the rod-shaped body 51b is pulled out by sliding the chuck portion.

Once the rod-shaped body 51b is formed, it can be continuously pulled out from the melted liquid 51a. Moreover, when forming the rod-shaped body 51b from the melted liquid 51a at first, the rod-shaped body 51b manufactured in advance may be set in the apparatus, or the rod-shaped body 51b may be pulled out using a seed crystal of the material.

The rod-shaped body 51b having been pulled out by the pullout mechanism 20 is fed along the feed guide 30. The feed guide 30 includes the roller 31 and the spring mechanism 32. These are fixed by a fixed post or a fixed guide. By using the feed guide 30, it is possible to obtain effects of preventing the rod-shaped body 51b from meandering, preventing the rod-shaped body 51b from being damaged by the stress whose fulcrum point is a chuck mechanism, and reducing a drive load of the pullout mechanism 20. The roller 31 is movable by the spring mechanism 32. Since the roller 31 is movable, a following capability of the roller 31 with respect to the change in shape and position of the rod-shaped body 51b improves, and the rod-shaped body 51b can be stably fed. The feed guide 30 may be omitted depending on situations (such as a case where there is no room for the feed guide due to limitations of the shape of the equipment). Moreover, the position of the roller 31 may be fixed as long as the effects of the present invention can be obtained.

The rod-shaped body 51b is moved toward the upper side of the crucible 41. The vicinity of the tip end portion of the rod-shaped body 51b is irradiated with an electron beam 42a emitted from the electron gun 42. The tip end portion of the rod-shaped body 51b is melted by the irradiation of the electron beam 42a to become liquid droplets 51c, and the liquid droplets 51c are dropped into the crucible 41. The electricity of the electron beam 42a is set in consideration of the type of the material and the shape and feed rate of the rod-shaped body 51b. For example, the electricity of the electron beam 42a is about 5 to 100 kW. In a case where the electricity of the electron beam 42a is less than 5 kW, the melting rate of the rod-shaped body 51b may not be enough. Moreover, in a case where the electricity of the electron beam 42a is more than 100 kW, the liquid droplet 51c may drop just before the crucible 41.

It is preferable that in order to omit the cutting step and cooling step of the rod-shaped body 51b and effectively utilize the rod-shaped body 51b, a space from the crucible 11 to the crucible 41 be disposed in one vacuum chamber. Meanwhile, the primary material replenishing mechanism 12 may be disposed in a second vacuum chamber coupled to the vacuum chamber (first vacuum chamber) in which the crucible 11 and the crucible 41 are disposed. These two vacuum chambers are divided by an openable and closable dividing plate. In the case of replenishing the primary material replenishing mechanism 12 with the solid material 51, these two vacuum chambers are divided by the dividing plate, the second vacuum chamber in which the primary material replenishing mechanism 12 is disposed is open to the atmosphere, and the solid material 51 is then replenished. After that, the second vacuum chamber is reduced in pressure, the dividing plate is open, and the primary material replenishing mechanism 12 replenishes the melting region 11a with the solid material 51. In accordance with this configuration, the solid material 51 can be replenished without reducing the degree of vacuum of the first vacuum chamber in which the crucible 11 and the crucible 41 are disposed.

A melted liquid (evaporation source) 51d of the solid material 51 is stored in the crucible 41. The melted liquid 51d is heated by an electron beam 42b emitted from the electron gun 42, and a part of the melted liquid 51d evaporates. The evaporated particles are deposited on the base material to form the thin film.

The electron beam emitted from the electron gun 42 is divided by the scanning mechanism into the electron beams 42a and 42b, and the rod-shaped body 51b and the melted liquid 51d are respectively irradiated with the electron beams 42a and 42b. By heating the rod-shaped body 51b and the melted liquid 51d using one electron gun 42, the apparatus can be simplified, and the cost of the apparatus can be reduced. The rod-shaped body 51b and the melted liquid 51d may be heated by different heating mechanisms. Moreover, the rod-shaped body 51b and the melted liquid 51d may be heated by a method other than the irradiation of the electron beam as long as the effects of the present invention can be obtained.

The crucible 41 has a recess 41a in which the melted liquid 51d is stored. A planar shape of the recess 41a may be any shape, such as a circular shape, an oval shape, a rectangular shape, or a doughnut shape, depending on the target film formation. The crucible 41 can be made of a heat resistant material. Examples of the material of the crucible 41 are: metals, such as copper, molybdenum, tantalum, and tungsten; alloys containing these metals; oxides, such as alumina, magnesia, and calcia; boron nitride; and carbon. One example of the crucible 41 is a water-cooling copper hearth.

In continuous vacuum deposition, such as a take-up type, the crucible 41 having the rectangular recess 41a which is longer than the width of the film formation may be used. Such crucible 41 is effective to form the film having a uniform thickness.

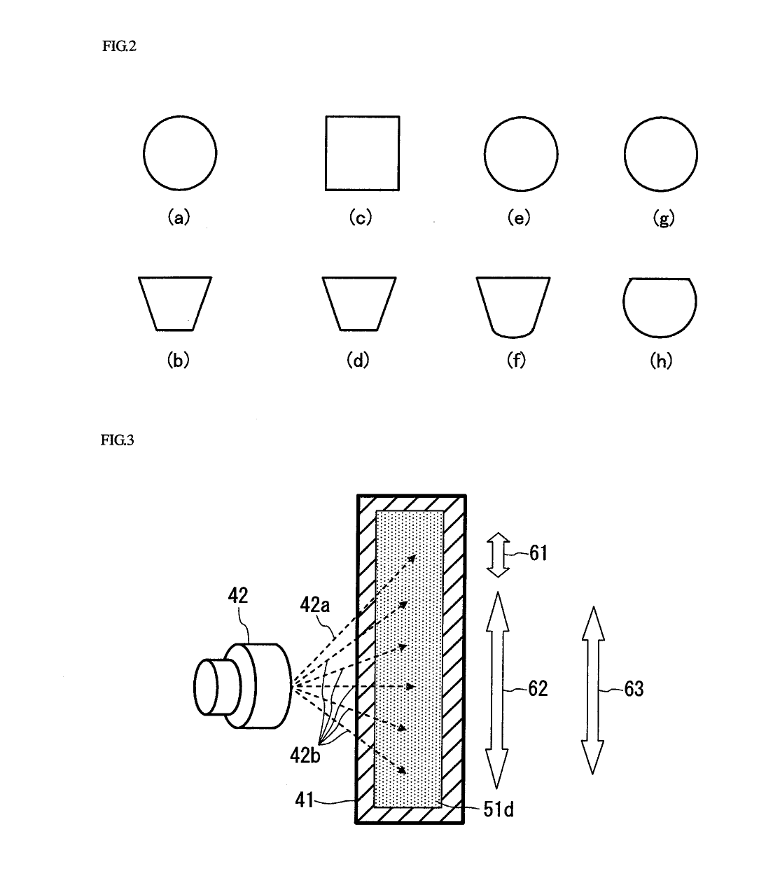

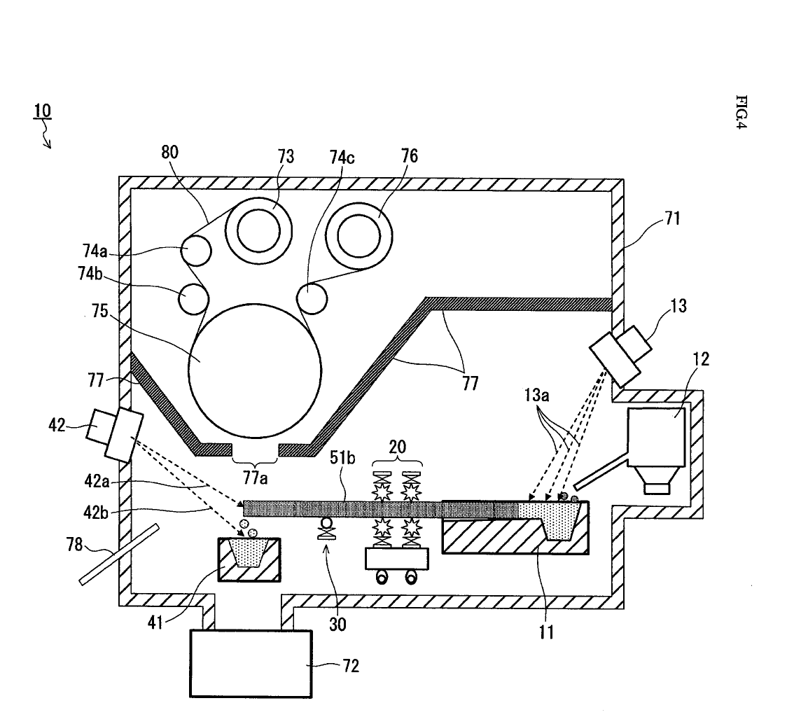

One example of an irradiation region of each of the electron beams 42a and 42b is shown in FIG. 3. An irradiation position 61 of the electron beam 42a with which the rod-shaped body 51b is irradiated is set to be spaced apart from a scanning range 62 of the electron beam 42b with which the melted liquid 51d is irradiated. Therefore, the liquid droplet 51c of the material is dropped on a position spaced apart from the scanning range 62 of the electron beam 42b. In accordance with this configuration, harmful influences (such as the temperature change of the melted liquid 51d and surface vibrations of the melted liquid 51d) caused by continuously supplying the liquid droplets 51c can be reduced. As a result, the uniform film can be formed. In one example of FIG. 3, the length of the scanning range 62 is set to be larger than a width 63 of the film formation.

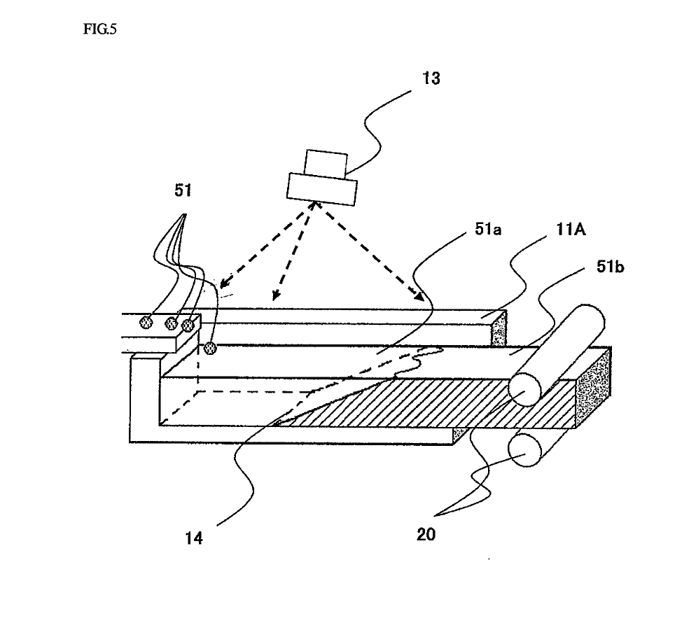

The entire film forming apparatus 10 is schematically shown in FIG. 4. A vacuum chamber 71 is a pressure-resistant chamber having an internal space. An exhaust unit 72 is connected to the vacuum chamber 71. The exhaust unit 72 causes the internal space of the vacuum chamber 71 to become a pressure-reduced state suitable for the film formation. For example, a pressure-reducing pump can be used as the exhaust unit 72.

In the internal space of the vacuum chamber 71, the crucible 11, the primary material replenishing mechanism 12, the pullout mechanism 20, the feed guide 30, the crucible 41, a delivery roller 73, feed rollers 74a to 74c, a can 75, a take-up roller 76, a shielding plate 77, and a material gas introduction tube 78 are disposed. Moreover, the electron guns 13 and 42 are fixed to a wall surface of the vacuum chamber 71.

The vacuum chamber 71 is divided by the shielding plate 77 into a substrate fed region where a substrate 80 is fed and a material processed region where the solid material 51 is processed. An opening 77a of the shielding plate 77 is formed in a region above the crucible 41. The vacuum chamber 71 may be a vacuum chamber formed by coupling a vacuum chamber including the substrate fed region and a vacuum chamber including the secondary material supplying mechanism 35. In this case, an openable and closable dividing plate is disposed on the opening 77a, and an exhaust unit is connected to the vacuum chamber including the substrate fed region.

Each of the delivery roller 73, the feed rollers 74a to 74c, the can 75, and the take-up roller 76 is a rotatable roller. These rollers serve as a feed mechanism configured to feed the substrate 80. The delivery roller 73 is disposed above the can 75 so as not to be contaminated by the evaporated material. The substrate (base material) 80 on which the film is not yet formed winds around the delivery roller 73. The substrate 80 is a band-shaped substrate.

The substrate 80 is delivered from the delivery roller 73 and passes through the feed rollers 74a and 74b to reach the can 75. A cooling unit (not shown) is provided inside the can 75. One example of the cooling unit is a cooling device configured to carry out cooling by the circulation of cooling water. When the substrate 80 moves on an outer peripheral surface of the can 75, the particles of the material flying from the evaporation source (melted liquid 51d) are deposited on the substrate 80 to form the thin film. In a case where the solid material 51 and a gas are caused to react with each other to form the film, the gas is introduced from the introduction tube 78. The take-up roller 76 is disposed above the can 75. The take-up roller 76 is rotated by a drive unit (not shown) and tales up the substrate 80 on which the thin film is formed.

The can 75 is disposed above the evaporation source (melted liquid 51d) with the opening 77a interposed therebetween. Material steam generated at the evaporation source passes through the opening 77a to reach the substrate 80 on the can 75. By depositing the material on the substrate 80, the thin film is formed on the substrate 80. By the shielding plate 77, a route along which the material particles flying from the crucible 41 reach the substrate 80 is limited only to the above route including the opening 77a.

The introduction tube 78 is provided according to need. As one example, one end of the introduction tube 78 is disposed above the crucible 41, and the other end thereof is connected to a material gas supplying unit (not shown) disposed outside the vacuum chamber 71. An oxygen gas, a nitrogen gas, and the like are supplied through the introduction tube 78. By supplying these gases, it is possible to form the thin film containing as a major component an oxide, nitride, or oxynitride of the material flying from the evaporation source. A gas bomb, a gas generating device, or the like is applicable as the material gas supplying unit.

In the film forming apparatus 10 of the present invention, the crucible (container) 11, the electron gun 13, the pullout mechanism 20, the feed guide 30, and the electron gun 42 serve as the secondary material supplying mechanism 35. The secondary material supplying mechanism 35 can continuously supply the material to the evaporation source. Therefore, in the film forming apparatus 10 of the present invention, the thin film can be formed continuously and stably. Normally, in the film forming apparatus 10, replenishing and melting of the solid material 51, pullout of the rod-shaped body 51b, melting of the rod-shaped body 51b, and film formation by heating of the melted liquid 51d are simultaneously and continuously carried out. However, these steps may not be simultaneously carried out and may be intermittently carried out as long as the effects of the present invention can be obtained.

In the film forming apparatus 10, the can 75 can be omitted. For example, the thin film may be formed on a part of the substrate 80 linearly moving between two feed rollers. An angle at which the material particle flies onto the substrate 80 can be changed depending on the positions of two feed rollers. For example, the material particles can be caused to be substantially perpendicularly incident on the surface of the substrate 80 or can be caused to be diagonally incident on the surface of the substrate 80. In accordance with the film forming method for causing the material particles to be diagonally incident on the surface of the substrate 80, the thin film including microspaces can be formed by a self-shadowing effect. Therefore, this film forming method is effective for the formation of a high C/N magnetic tape, the formation of a negative pole of a battery having an excellent cycle characteristic, and the like.

In the film forming apparatus 10 of the present invention, an elongated negative pole for a battery is obtained by using an elongated copper foil as the substrate 80 and using silicon as the solid material 51.

One example of a method for forming a silicon thin film will be explained. In this example, the #441 grade metal silicon is supplied from the primary material replenishing mechanism 12 to the crucible 11 at a rate of 3 g/sec. The metal silicon is melted by the irradiation of the 50 kW electron beam emitted from the electron gun 13. The unshaped rod-shaped body 51b having a diameter of about 50 mm is formed from the melted liquid of the metal silicon at a rate of 6 cm/min. The tip end of the rod-shaped body 51b above the deposition crucible 41 is irradiated with the 40 kW electron beam emitted from the electron gun 42. By the irradiation of the electron beam, the tip end of the rod-shaped body 51b is melted, and the silicon is supplied to the crucible 41. Moreover, the crucible 41 is irradiated with the 90 kW electron beam emitted from the electron gun 42. By irradiating the crucible 41 with the electron beam, the silicon thin film is formed on the substrate.

Moreover, one example of a method for forming a magnetic tape containing cobalt will be explained. In this example, polyethylene terephthalate is used as the substrate, and cobalt is used as the solid material 51. The cobalt evaporates from the crucible 41. Moreover, an oxygen gas is introduced through the introduction tube 78. As a result, an elongated magnetic tape is obtained.

### Embodiment 2 of Film Forming Method and Film Forming Apparatus

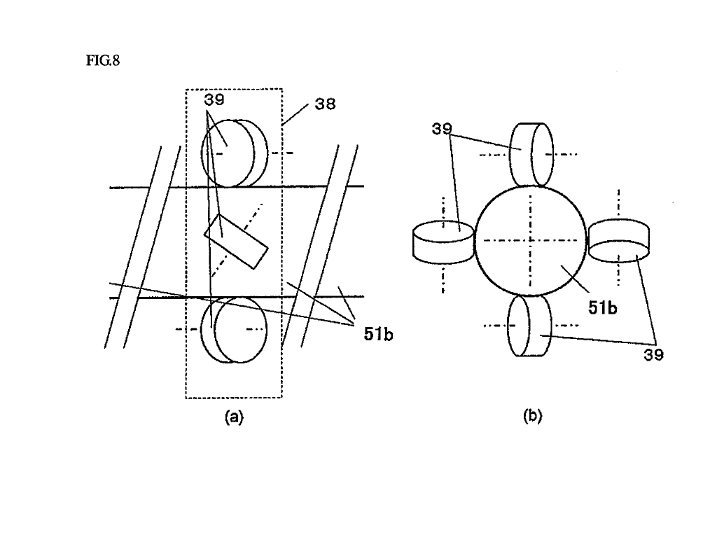

The configuration of Embodiment 2 of the film forming apparatus of the present invention is schematically shown in FIG. 7. In FIG. 7, the vacuum chamber, the exhaust mechanism, the base material, and the base material feed mechanism are not shown. FIG. 1(a) is a top view, and FIG. 1(b) is a side view (partial cross-sectional view). Explanations of the same components as in FIG. 1 will be omitted.

In FIG. 7, the pullout mechanism 20 includes a rotating mechanism 38. The rod-shaped body 51b is rotated by the rotating mechanism 38 and pulled out by the chuck rollers 21 and the like. The rotating mechanism 38 can use a roller system, a gear system, or the like. For example, by rod-shaped body rotating rollers 39 having convex portions, the rod-shaped body can be rotated while being sandwiched vertically and horizontally. The sandwiching pressure differs depending on the material quality, shape, and pullout rate of the rod-shaped body to be manufactured, but is, for example, 3 to 50 kgf. In a case where the sandwiching pressure is too low, the rod-shaped body may slip and may not be smoothly pulled out. In contrast, in a case where the sandwiching pressure is too high, the rod-shaped body may deform or break. Since the rod-shaped body has not a complete cylindrical shape but an unshaped side surface in many cases, the sandwiching by the rod-shaped body rotating rollers 39 is unlikely to become stable. Here, it is desirable that a sandwiching mechanism of the rod-shaped body rotating roller 39 include a cushioning mechanism, such as a spring. The rod-shaped body can also be rotated by pressing a gear-shaped rotating body to the rod-shaped body.

It is preferable that in order to realize both the rotation of the rod-shaped body and the pullout of the rod-shaped body, for example, sandwiching for the rotational movement of the rod-shaped body and sandwiching for the horizontal movement of the rod-shaped body be alternately carried out according to need. With this, a twisting stress applied to the rod-shaped body can be reduced, so that the damage of the rod-shaped body by the twisting stress can be prevented. Moreover, by using as a drive mechanism configured to realize both the rotation of the rod-shaped body and the pullout of the rod-shaped body a chuck roller configured to drive in an oblique direction with respect to the rod-shaped body as shown in FIG. 8, the drive mechanism can also serve as the rotating mechanism.

The number of rotations of the rod-shaped body differs depending on the material quality, shape, and, pullout rate of the rod-shaped body to be manufactured, but is, for example, 0.5 to 4 rpm at the pullout rate of 1 to 10 cm/min.

In a case where the cross-sectional shape of the groove 11g of the shaping region 11b is a semicircular shape, voids are sequentially formed at the groove portion as the rod-shaped body rotates. The material melted in the melting region 11a sequentially flows into the voids. Therefore, by pulling out the rod-shaped body while rotating the rod-shaped body, the rod-shaped body having a substantially circular cross-sectional shape can be obtained.

The shape of the upper surface of the rod-shaped body obtained in FIG. 1 is not defined, and a large number of depressions and projections exist. However, the number of depressions and projections on the surface of the rod-shaped body having a substantially circular cross-sectional shape obtained in FIG. 7 are comparatively small. Therefore, the rod-shaped body is unlikely to be damaged by the pullout mechanism 20 or the feed guide 30.

Moreover, in FIG. 7, since the rod-shaped body has a substantially circular cross-sectional shape and is rotated, the vicinity of the tip end portion of the rod-shaped body can be uniformly irradiated with the electron beam 42a. Therefore, a portion of the rod-shaped body which portion remains unmelted is unlikely to be generated, and the change in a melted state becomes small. As a result, a dropping rate and dropping position of the liquid droplet dropping to the crucible 41 become stable, so that the evaporation rate from the crucible 41 can also become stable.

### Manufacturing of Negative Pole of Lithium Ion Secondary Battery

As described above, the film forming method and film forming apparatus of the present invention are applicable to manufacturing of a polar plate of a secondary battery, and specifically applicable to manufacturing of a negative pole of a lithium ion secondary battery. In this case, a material constituting a negative pole active material can be used as the material of the film formation. As the material constituting the negative pole active material, silicon or tin can be used, and metal silicon or a silicon alloy can be typically used. Moreover, as the base material (substrate), an electrically conductive base material is used. For example, as the base material, a copper foil (having a thickness of 5 to 30 μm for example) or a polymer film (such as PET, PEN, PPS (polyphenyl sulfide), polyamide, or polyimide film) on which a copper thin film (having a thickness of 0.2 to 20 μm for example) is deposited can be used. Moreover, a metal foil (such as a copper foil) having a surface on which depressions and projections are formed may be used.

A negative pole active material layer formed on the base material has a thickness of 5 to 30 μm for example. The negative pole active material layer is formed on one surface of the base material or each of both surfaces thereof.

The negative pole active material layer may be formed by using silicon as the evaporation source and introducing an oxygen gas. Moreover, the negative pole active material layer may include lithium in addition to silicon. Lithium can be added to the negative pole active material layer by, for example, codeposition with silicon.

In the case of manufacturing the negative pole of the lithium ion secondary battery, an angle of an incident direction of the evaporated particle flying from the evaporation source onto the base material with respect to a normal direction of the base material may be in a range from 10° to 80°. Moreover, assuming that an angle of inclination with respect to a proceeding direction of the base material is positive, the above angle of the incident direction of the evaporated particle with respect to the normal direction of the base material may be changed between a range from +10° to +80° and a range from −10° to −80° at regular time intervals. The incident direction of the material particle is an average of the incident directions of all the material particles. For example, the incident direction of the material particle is represented by a direction in which a center portion of the irradiation region of the electron beam 42a and a center portion of the opening 77a are connected.

By changing the angle of the surface of the base material with respect to the incident direction of the material particle, the material can be deposited in a column shape or in a zigzag shape on the surface of the base material. These technologies are disclosed in WO2007/052803 and WO2007/015419 for example. Examples of the method for changing the angle of the surface of the base material with respect to the incident direction of the material particle are a method for changing the position of the feed roller and the method for providing two deposition regions which are different from each other in the angle of incidence of the material particle.

The foregoing has explained the embodiments of the present invention using examples. However, the present invention is not limited to the above embodiments. The present invention is applicable to various devices which requires stable film formation. For example, the present invention is applicable to condensers, sensors, solar batteries, optical films, moisture-proof films, electrically conductive films, and the like.

### INDUSTRIAL APPLICABILITY

The present invention can be utilized for the film forming apparatus and the film forming method.

1. A film forming method for forming a thin film, comprising the steps of:
(i) melting a solid material of the thin film to prepare a melted liquid, solidifying the melted liquid to form a rod-shaped body, and pulling out the rod-shaped body;
(ii) melting and supplying a part of the rod-shaped body to an evaporation source; and
(iii) using the evaporation source to form the thin film, wherein
the steps (i), (ii), and (iii) are carried out in vacuum.

2. The film forming method according to claim 1, wherein the steps (i), (ii), and (iii) are simultaneously carried out.

3. The film forming method according to claim 1, wherein:
in the step (ii), the part of the rod-shaped body is heated and melted by an electron gun; and
in the step (iii), the evaporation source is heated and evaporated by the electron gun.

4. The film forming method according to claim 1, wherein when the material is supplied through one end of a crucible and heated and melted to prepare the melted liquid, and the melted liquid is then solidified by cooling down the melted liquid at the other end of the crucible to form the rod-shaped body in the step (i), the melted liquid is cooled down from below through the crucible and heated from above.

5. The film forming method according to claim 1, wherein the material is a material which causes volume expansion during solidification.

6. The film forming method according to claim 1, wherein the material is silicon or an alloy containing silicon.

7. The film forming method according to claim 4, wherein the crucible is made of a cooled metal.

8. The film forming method according to claim 7, wherein the crucible is made of a cooled copper.

9. The film forming method according to claim 4, wherein a side of the crucible to which side the material is supplied and a side of the crucible at which side the rod-shaped body is formed are made of different materials, and a heat transfer rate between the material of the side of the crucible to which side the material is supplied and the melted liquid of the material is lower than a heat transfer rate between the material of the side of the crucible at which side the rod-shaped body is formed and the melted liquid of the material.

10. The film forming method according to claim 9, wherein the side of the crucible to which side the material is supplied is made of graphite.

11. The film forming method according to claim 9, wherein the side of the crucible at which side the rod-shaped body is formed is made of a cooled metal.

12. The film forming method according to claim 11, wherein a solidification start line of the rod-shaped body exists on the cooled metal.

13. The film forming method according to claim 4, wherein a side surface of the crucible and a bottom surface of the crucible are made of different materials, and a heat transfer rate between the material of the side surface of the crucible and the melted liquid of the material is lower than a heat transfer rate between the material of the bottom surface of the crucible and the melted liquid of the material.

14. The film forming method according to claim 4, wherein a method for heating the melted liquid from above during solidification is a method using an electron gun.

15. The film forming method according to claim 4, wherein a method for heating the melted liquid from above during solidification is a method using resistance heating.

16. The film forming method according to claim 4, wherein a heating region during heating and melting and a heating region during solidification are adjacent to each other.

17. The film forming method according to claim 1, wherein the rod-shaped body is pulled out while being rotated in the step (i).

18. The film forming method according to claim 17, wherein the rod-shaped body has a substantially circular cross-sectional shape.

19. The film forming method according to claim 1, wherein the steps (i), (ii), and (iii) are carried out in one vacuum chamber or in a plurality of vacuum chambers coupled to one another.

20. The film forming method according to claim 1, wherein the rod-shaped body is supplied to the evaporation source in the step (ii) by dropping a melted liquid generated by melting the part of the rod-shaped body.

21. A film forming apparatus configured to generate a secondary material from a primary material and evaporate the secondary material to form a thin film on a base material in vacuum,
the film forming apparatus comprising:
a vacuum chamber;
an exhaust mechanism configured to exhaust air from the vacuum chamber;
an evaporation source disposed in the vacuum chamber to evaporate the secondary material;
a secondary material supplying mechanism including a first heating mechanism configured to heat the primary material in a solid state to prepare a melted liquid, a container configured to form a rod-shaped body from the melted liquid, a pullout mechanism configured to pull out the rod-shaped body, and a second heating mechanism configured to melt a part of the rod-shaped body and supply a melted material as the secondary material to the evaporation source;
a base material feed mechanism configured to feed the base material to a position on which evaporated particles evaporated from the evaporation source are deposited; and
a primary material replenishing mechanism configured to replenish the secondary material supplying mechanism with the primary material in the solid state.

22. The film forming apparatus according to claim 21, wherein:
the base material is a band-shaped substrate; and
the feed mechanism includes a first roller configured to feed the substrate and a second roller configured to take up the substrate.

23. The film forming apparatus according to claim 21, wherein:
the container includes a melted liquid storing portion configured to store the melted liquid of the material and a shaping portion adjacent to the melted liquid storing portion; and
the shaping portion solidifies the melted liquid to form the rod-shaped body.

24. The film forming apparatus according to claim 23, wherein:
the shaping portion is provided with a groove through which the rod-shaped body passes; and
a width of the groove increases from the melted liquid storing portion side toward the shaping portion side.

25. The film forming apparatus according to claim 21, wherein the first heating mechanism includes an electron gun.

26. The film forming apparatus according to claim 21, wherein the second heating mechanism includes an electron gun.

27. The film forming apparatus according to claim 26, wherein:
the second heating mechanism includes a scanning mechanism configured to distribute an electron beam, emitted from the electron gun, to the rod-shaped body and the evaporation source; and
the evaporation source is heated using the electron gun.

28. The film forming apparatus according to claim 21, wherein the pullout mechanism includes a swing mechanism configured to swing the rod-shaped body.

29. The film forming apparatus according to claim 21, wherein:
the first heating mechanism is disposed above the container; and
a tail end of the heating region heated by the first heating mechanism is provided on a side of a solidification start line of the rod-shaped body at which side the rod-shaped body is formed.

30. The film forming apparatus according to claim 21, wherein the pullout mechanism includes a rotating mechanism configured to rotate the rod-shaped body.
